(19) United States
(12) Patent Application Publication
(10) Pub. No.: US 2018/0056345 A1
(43) Pub. Date: Mar. 1, 2018

(54) METHOD OF EX-SITU REMEDIATION FOR CONTAMINATED SOIL

(71) Applicant: TRIUM ENIRONMENTAL INC., Cochrane (CA)

(72) Inventors: Byong Jun MIN, Calgary (CA); Jevins Lee WADDELL, Cochrane (CA)

(21) Appl. No.: 15/557,043

(22) PCT Filed: May 20, 2016
(86) PCT No.: PCT/CA2016/050580

§ 371 Date: Sep. 8, 2017

(30) Foreign Application Priority Data
May 22, 2015 (KR) 10-205-0072020

(51) Int. Cl. B09C 1/08

(52) U.S. Cl. CPC B09C 1/08

(57) ABSTRACT

Methods for remediation of contaminated soil are provided including spraying blended hydrogen peroxide solution onto excavated and laid out soil on the ground and mixing or blending them concurrently by a specialized tractor that is equipped with an oxidant tank in the front and, a spray nozzle system and a reversely rotating soil mulching device in the rear so as to optimize soil moisture content for efficient oxidative reaction and reduced remediation timeframe.

### TECHNICAL FIELD

Generally, embodiments of this invention relate to methods of remediating soil contaminated with organic compounds, and more specifically related to remediating contaminated soil by concurrently spraying an oxidant solution and blending the contaminated soil.

### BACKGROUND

The industrialization and economic development of modern society has contributed to highly increased production, distribution and use of petroleum hydrocarbon based fuels as well as petrochemical products. These organic compounds and their storage facilities have resulted in significant contamination in surface and subsurface soil and groundwater.

Releases and spills of organic compounds cause, not only a direct impact to soil, but also a secondary impact to other environmental media such as surface water and groundwater.

Currently, in the Republic of Korea for example, it is reported that 12,917 retail fueling stations and 7,347 storage facilities are registered and are regulated as soil contamination source facilities. Released and/or spilled fuels due to outdated infrastructure and/or environmental incidents, often result in significant soil and groundwater contamination.

The hydrocarbons, such as fuels, are hydrophobic and tend to be absorbed in soil pores or be present as non-aqueous phase liquids (NAPLS) upon release into soil. These fuels are comprised of complex mixtures of petroleum hydrocarbons (PHCs) that require remedial treatment due to adverse toxicological effects to humans and soil environments.

Remediation technologies for PHC impacted soil can be categorized by the place of remediation occurrence, such as in-situ, which is remediation under the ground, and ex-situ, which is treatment above ground. Further to technical methods, remediation technologies are categorized into three areas: physical, biological and chemical treatment. Physical technologies can include remedial excavation and landfill disposal, capping, pump & treatment, vapour extraction, solidification, hydraulic fracturing, thermal desorption, and plasma vitrification. Chemical technologies can include oxidation, neutralization, ion exchange, soil washing, surfactant flushing, encapsulation, etc. Biological technologies can include engineered bioremediation, bio venting and land farming.

Among those technologies, chemical oxidation techniques using oxidants, such as hydrogen peroxide, has been proven to be efficient and versatile for field application as it mineralizes petroleum hydrocarbons to carbon dioxide and water within a very short timeframe in comparison to other technologies. Although this technology has advantages, it can be less cost effective and less efficient at sites with contaminated soil with high concentrations due to the excessive dose requirements of oxidants and resulting costs.

Korean Registered Patent Serial No. 10-1146785 discloses an ex-situ chemical oxidation method for remediating petroleum hydrocarbon impacted soil by ex-situ chemical oxidation which employs an in-place mixing method. An excavator is used to mix the treated soil and a hydrogen peroxide solution which is activated by chelators such as FeCl₂ or FeSO₄.

Korean Registered Patent Serial No. 10-1196987 also discloses a method using a tractor equipped with a conventional agricultural plowing device and a different chelating technique, such as NaSO₄ or CaH₂O₂ for hydrogen peroxide.

However, the disclosures of the prior art fail to establish and/or maintain optimum soil moisture content (15 to 25%) for effective remedial reactions in soil with the applied chemical oxidant and also to minimize the loss and poor distribution of applied oxidant solutions in the treated soil due to ineffective mixing devices such as a conventional excavator or agricultural plowing device and those challenges often result in lower remediation performance and/or reproducibility in each treatment batch or aliquot.

### SUMMARY

Embodiments of this invention provide for an ex-situ (above ground) remedial method of soil contaminated with organic compounds. In embodiments, an ex-situ method can comprise preparation of excavated soil by spreading it out on the surface, and spraying oxidant solution and concurrently mixing or blending with the soil.

In a broad aspect of the invention, an ex-situ remediation method for soil contaminated with organic compounds comprises excavating the contaminated soil and spreading the excavated soil along a ground surface to a thickness of about 30 cm to 50 cm, and spraying an oxidant solution along the excavated soil and concurrently mixing the excavated soil with the oxidant solution. The oxidant solution comprises hydrogen peroxide, a catalyst, and a diluent.

In another broad aspect of the invention, a specialized tractor that is equipped with an oxidant blend tank, reversely rotating soil mulching device, and injection nozzles attached in the mulching device can be used to establish optimum soil moisture content and oxidative reaction conditions by efficient mixing or blending of the soil and the applied oxidant solution. This invention improves soil treatment efficiency by increasing treatable soil volume per day as well as decreasing treatment timeframes to satisfy regulatory remediation criteria.

Embodiments of this invention have been developed to overcome the technical difficulties known in the industry, and provides technical advancements including increased volume of soil treated per day and reduces remediation timeframes.

Embodiments of this invention provide technical advantages to treat a large volume of contaminated soil effectively by establishing optimum soil moisture in the soil that is laid out on the surface after being excavated and then mixing the contaminated soil and the applied oxidant homogeneously within the reversely rotating mulching device, as the tractor moves forward, and the oxidant is sprayed to the soil concurrently.

Furthermore, certain embodiments of the presently disclosed advanced processes desirably provide other advantages in decreasing remediation timeframe due to the efficiency associated therewith.

### BRIEF DESCRIPTION OF THE DRAWINGS

FIG. 1 is a flow chart illustrating the steps of an ex-situ remediation method according to an embodiment of the invention including excavating contaminated soil, spreading the contaminated soil along a surface; spraying oxidant solution onto the contaminated soil, and concurrently blending the contaminated soil while spraying the oxidant solution; and

FIG. 2 is a representative schematic of an embodiment of the invention illustrating a tractor having an oxidant blend tank and a reversibly rotating soil mulcher.

### DETAILED DESCRIPTION

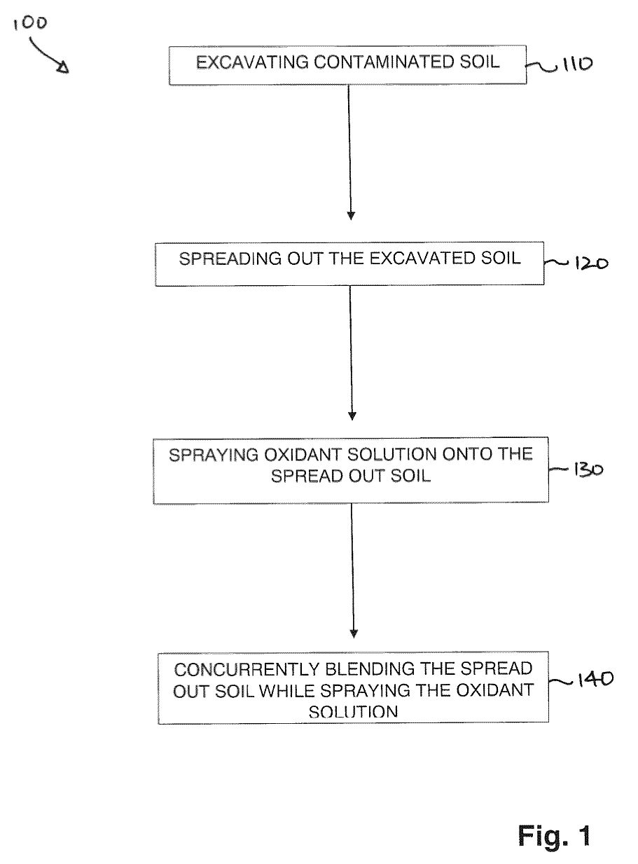

Embodiments of this invention are directed to a method of remediating contaminated soil 100 such as that illustrated in the flow chart of FIG. 1, including excavating contaminated soil 110 such as by use of an excavator, and spreading the excavated soil over a ground surface 120, such as to an exemplary thickness of about 30 to 50 cm, and then spraying an oxidant solution onto the contaminated soil 130, and concurrently mixing or blending the oxidant solution and soil 140, such as with a soil mulching device. In one embodiment, the blended oxidant solution comprises hydrogen peroxide 50% wt. solution, 0.1 to 2.5% wt. of FeCl₂ or FeSO₄, relative to the 50% wt of hydrogen peroxide, as a catalyst and 180 to 1000% wt. of water, relative to the 50% wt of hydrogen peroxide, as a diluent.

The first steps of the above said embodiment of this method is the preparation of petroleum hydrocarbon contaminated soil by excavation 110 and spreading of the contaminated soil in a layer on the surface of ground 120, such as in a layer with a thickness of 30 to 50 cm, for example. In one embodiment, this soil preparation expedites oxidation processes by exposing soil pores and surface area to ambient air. In one embodiment, the optimum thickness of the soil can be suggested in a range between 30 to 50 cm. In one such embodiment, Applicant found that a thickness less than 30 cm decreases soil treatment volume and efficiencies, which also decreases cost effectiveness. Whereas, a thickness over 50 cm prohibits desirable soil and oxidant mixing or blending conditions due to an excessive amount of soil volume for the mixing device, particularly in fine grained soil which results in poorly mixed chunks of soil and oxidant.

A soil moisture content is typically in range between 5 to 18%. Due to oxidative reaction conditions, which occurs in the pore water phase within the soil, in one embodiment it is desirable to add water as required to optimize soil moisture to be in a preferred range of 15 to 25%.

The process listed in the above-referenced Korean Patent No. 10-1196987, typically requires an extra task of adding water to optimize soil moisture content in the oil prior to application of oxidants, after excavating and spreading out the contaminated soil. However, embodiments of this presently disclosed invention do not require this extraneous task, as it employs spraying the oxidant solution (and diluted water to maintain optimum soil moisture content) onto the contaminated soil while mixing or blending concurrently such as within a reversely rotating soil mulching device as the tractor moves forward.

It is recommended to blend an oxidant solution by combining hydrogen peroxide 50% solution, 0.1 to 2.5% wt. of FeCl₂ or FeSO₄, relative to the 50% wt of hydrogen peroxide, and 180 to 1000% wt. of water, relative to the 50% wt of hydrogen peroxide.

As mentioned earlier, certain methods according to the prior art typically need an extra process to add water to the contaminated soil prior to mixing with the soil and oxidant(s). In contrast, in one embodiment of the present invention, a desirable or optimum soil moisture content (e.g. 15 to 25%) may be established concurrently with soil mixing or blending, such as by spraying a blended oxidant solution onto the contaminated soil 130 and mixing or blending the soil concurrently with the application or spraying of the oxidant solution 140, which desirably reduces the treatment time significantly, as it eliminates the extra process.

In some applications, when soil moisture content is too high, it typically prevents air flow in soil pores, whereas when it is too low, it inhibits microbial activities.

In certain embodiments, when soil moisture content is lower than the desired or optimum condition, water can be added to the oxidant solution and be sprayed from nozzles in fluid communication with an oxidant blend tank, such as may be secured on a tractor.

In certain embodiments, if site conditions are subject to precipitation (i.e. rain), in order to assist in controlling the soil moisture content, it may be preferred that the method be carried out under a roof structure or other covering to prevent the precipitation from increasing soil moisture in the treated soil beyond a desired or optimal level.

In one embodiment, concurrent with spraying the contaminated soil, the soil is blended with an oxidant solution containing hydrogen peroxide 50% solution, 0.1 to 2.5% wt. of FeCl₂ or FeSO₄, relative to the 50% wt of hydrogen peroxide, a catalyst and 180 to 1000% wt. of water, relative to the 50% wt of hydrogen peroxide, and a diluent. In one such embodiment, the oxidant solution has hydroxyl radicals that reacts with and oxidizes the PHC contaminants within the soil.

In a further embodiment, a 50% hydrogen peroxide solution used can be transported from a storage tank and be diluted with water in a mixing tank to an optimum blending solution for application and to generate hydroxyl radical as shown on the below Formula 1.

H₂0₂->2OH⁻ (Formula 1)

In a particular embodiment, the generated hydroxyl radical may desirably oxidize petroleum hydrocarbons (PHCs) in soil as shown on below Formula 2.

OH+M(PHCs)->breakdown products (Formula 2)

However, it may be understood that hydrogen peroxide is typically very unstable, hence it can react with other chemicals in soil or decompose itself.

2H₂O₂+X(other chemicals in soil)->0₂+H₂0 (Formula 3)

As described above, in one embodiment, hydrogen peroxide solution applied to contaminated soil tends to react with not only the target contaminant (PHCs) but also other chemicals in the soil, and therefore requires a sufficient dose of hydrogen peroxide to overcome the loss. It is important to confirm a reaction rate between hydrogen peroxide and the target contaminant in the soil. Generally the reaction occurs in an first degree order therefore it is required to estimate an optimum dose in accordance with a first degree reaction constant and understanding of the kinetics between the contaminant and the oxidant dose rate using a formula such as formula 4 in the following.

dC/dt=kC (Formula 4)

C indicates concentration of PHCs

In accordance with Formula 4, embodiments of the invention can use a 50% hydrogen peroxide solution; which is blended with a catalyst and water to optimize the oxidative effectiveness.

In one embodiment, when a ratio of a catalyst is less than 0.1% weight basis, it may not generate sufficient oxidative reactions, whereas if over 2.5% wt., it may not provide significant further enhanced reactions and results in higher chemical costs. In another embodiment, when a blending ratio with water is less than 180%, it could cause a rapid reaction and over 1000% of dilution could cause extended treatment timeframes and limited reaction efficiencies due to excessive water content.

Meanwhile, a catalytic additive (promoter), including: ethylene-diamine-tetra-acetic-acid (EDTA), hydroxyl-ethyl-imino-diacetic-acid, S,S′-ethylene-diamine-disuccinate or nitrilo-triacetic-acid can enhance oxidative reactions. Similar to the catalyst, when a ratio of a catalytic additive is less than 0.01% weight basis, it may not generate sufficient oxidative reactions, whereas if over 2.5% wt. of the catalyst is applied, it may not provide a significant enhanced reactions and results in higher chemical costs.

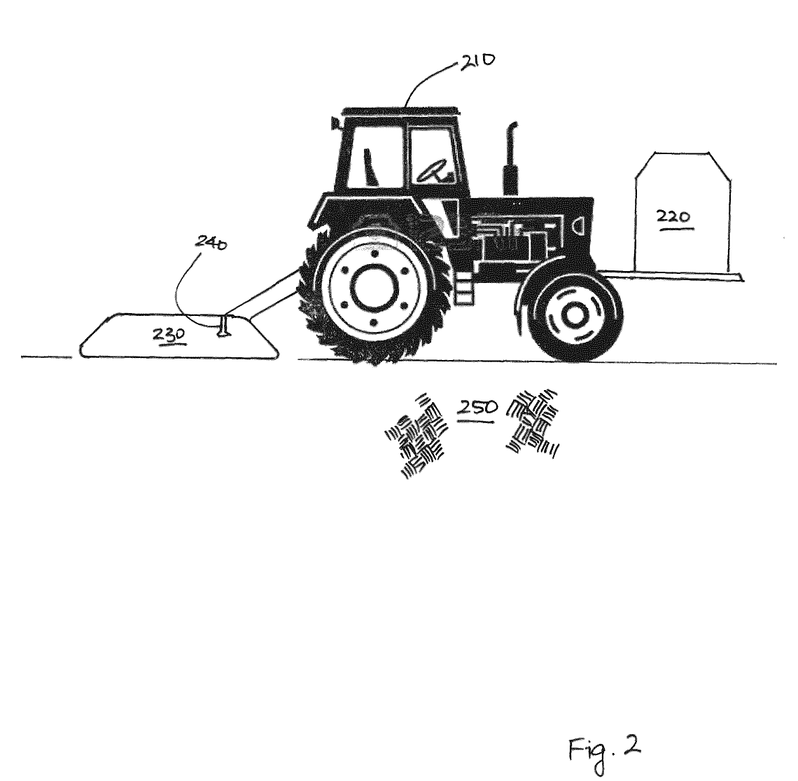

In certain embodiments, such as illustrated in the exemplary embodiment shown in FIG. 2, the above described hydrogen peroxide based blended oxidant solution can be sprayed onto a contaminated soil 250 by nozzles 240 installed within a suitable soil mixing or blending device 230, such as an exemplary reversely rotating soil mulching device 230, such as may be supported at the rear of a tractor 210, for example. In one such embodiment, the blended oxidant solution can be stored in a tank 220 supported by the tractor 210, which may be fluidly connected to supply oxidant solution to the nozzles 240 for spraying onto the contaminated soil 250, for example. The blended oxidant solution then is conveyed through the soil pores by gravity drainage and mixing of the mulching device 230 while the tractor 250 moves forward.

The soil oxidation process may require extra mixing or blending to expedite the reactions after the application.

An ideal remediation site plan would include soil erosion controls and a site access road, and the location of the treatment area should be located in the proximity to the exaction area to reduce on-site transportation. The treatment area can be made up of one or multi treatment pads based on the target remediation timeframe and size of the site.

### Field Experiment

In one experimental embodiment, a series of field experiments were conducted at a former fuel storage site. 50 m² of the contaminated area was selected and a total of 100 m³ of the contaminated soil was excavated in a depth to 2 meters below surface. The soil moisture content was reported to be 13%.

A chemical analysis of the contaminated soiled revealed the presence of benzene, ethylbenzene, xylene and total petroleum hydrocarbon (TPH) contamination in the soil. The concentrations of each of the contaminating chemicals found are listed in Table 1 below.

TABLE 1
Contaminant concentrations before treatment (Control)

| Contaminant | Benzene | Ethylbenzene | Xylene | TPH |
|---|---|---|---|---|
| Concentration | 0.023 | 0.062 | 0.049 | 916 |
| (ppm) | | | | |

### Sample 1

For a first sample, an excavator was used to excavate a portion of the contaminated soil and spread out with a thickness of 40 cm on the surface as preparation. A tractor equipped with an oxidant solution tank in the front and a reversely rotating soil mulching device in the rear, sprayed the oxidant solution to the soil and concurrently mixed the oxidant and soil within the soil mulching device, as the tractor moved forward. The blended oxidant solution was comprised of hydrogen peroxide 50% wt. solution, 1.0% wt. of FeCl₂ as a catalyst and diluted with 500% wt. of water. The moisture content of the treated soil was measured to about 20.1% after oxidant application. Upon completion of the process, 500 grams of soil was sampled for chemical analysis, and tabulated in Table 2.

### Sample 2

The steps used in obtaining Sample 1 were repeated to obtain Sample 2. However, in contrast to Sample 1, 1% of FeSO₄ instead of FeCl₂ was applied. The results of the chemical analysis is tabulated in Table 2.

### Sample 3

The steps used in obtaining Sample 1 were repeated to obtain Sample 3. However, in contrast to Sample 1, 2% of FeCl₂ and 950% of water were applied. The results of the chemical analysis is tabulated in Table 2.

### Sample 4

The steps used in obtaining Sample 1 were repeated to obtain Sample 4. However, in contrast to Sample 1, 3% of FeCl₂ and 1050% water were applied. The results of the chemical analysis is tabulated in Table 2.

### Sample 5

The steps used in obtaining Sample 1 were repeated to obtain Sample 5. However, in contrast to Sample 1, 0.09% of FeCl₂ and 170% water were applied. The results of the chemical analysis is tabulated in Table 2.

### Sample 6

The steps used in obtaining Sample 1 were repeated to obtain Sample 6. However, in contrast to Sample 1, 1% of ethylene-diamine-tetra-acetic-acid (EDTA) was added as a catalytic additive (promoter) was applied. The results of the chemical analysis is tabulated in Table 2.

### Prior Art Sample

10 m³ of the contaminated soil was stockpiled, a blended solution of 750 kg of 17% of hydrogen peroxide and 20 kg of FeSO₄ was applied to the soil aliquot and was mixed with an excavator. After mixing, an agricultural plow tractor turned the soil 4 times and waited for 48 hours for oxidative reactions to complete. 500 grams of soil was sampled for chemical analysis.

### Chemical Analysis of Treated Soil Samples

All the soil samples collected example were analyzed by a gas chromatography (HP6890 Plus) for benzene, ethylbenzene, xylene and total petroleum hydrocarbons (TPH) in accordance with a soil analytical standard method. The results are summarized in Table 2 and are compared to the results of the control sample in Table 1.

TABLE 2
Soil Chemical Analysis - Before (Control) and After Experiments

| | [Benzene] | [Ethylbenzene] | [Xylene] | [TPH] |
|---|---|---|---|---|
| Contaminant | (ppm) | (ppm) | (ppm) | (ppm) |
| Control | 0.023 | 0.062 | 0.049 | 916 |
| Sample 1 | 0.013 | 0.026 | 0.030 | 781 |
| Sample 2 | 0.012 | 0.025 | 0.031 | 783 |
| Sample 3 | 0.016 | 0.024 | 0.027 | 778 |
| Sample 4 | 0.018 | 0.037 | 0.031 | 807 |
| Sample 5 | 0.016 | 0.040 | 0.033 | 821 |
| Prior Art Sample | 0.018 | 0.041 | 0.035 | 850 |

As shown on Table 2, the concentration of benzene was lowest in Sample 2, while concentrations of ethylbenzene, xylene, and TPH were lowest in Sample 3. Overall, based on the chemical analysis, it appears that greatest reduction in the concentrations of the contaminants were found in Samples 1 to 3.

In comparison to conventional technologies, embodiments according to aspects of the present invention desirably may not require pre-moisturizing processes to optimize soil moisture content prior to spraying oxidant solution to contaminated soil, allowing the remediation process to be completed within 3 days. This may desirably provide an economic advantage to be able to treat a large volume of contaminated soil effectively, such as over 500 m³ of soil per day, for example. Furthermore, and as shown in Table 2, embodiments of the invention result in increased reduction of contaminants as compared to remediation using known methods.

Various modifications to those embodiments will be readily apparent to those skilled in the art, and the generic principles defined herein may be applied to other embodiments without departing from the scope of the invention. Thus, the present invention is not intended to be limited to the embodiments shown herein.

We claim:

1. An ex-situ remediation method for soil contaminated with organic compounds comprising:
excavating the contaminated soil and spreading the excavated soil along a ground surface to a thickness of about 30 cm to 50 cm; and
spraying an oxidant solution along the excavated soil and concurrently mixing the excavated soil with the oxidant solution,
wherein the oxidant solution comprises hydrogen peroxide, a catalyst, and a diluent.

2. The oxidant solution of claim 1, wherein the hydrogen peroxide comprises 50% by weight of the solution.

3. The oxidant solution of claim 1 or 2, wherein the catalyst further comprises 0.1 to 2.5% by weight of FeCl₂ or FeSO₄.

4. The oxidant solution of claim 1, 2 or 3, wherein the diluent further comprises 180% to 1000% by weight of water.

5. The oxidant solution of any one of claims 1 to 4, further comprises 0.01% to 2.0% by weight of a catalytic additive.

6. The oxidant solution of claim 5, wherein the catalytic additive further comprises one of ethylene-diamine-tetra-acetic-acid (EDTA), hydroxyl-ethyl-imino-diacetic-acid; S,S′-ethylene-diamine-disuccinate or nitrilo-triacetic-acid.

7. An apparatus for carrying out any one of the methods of claims 1 to 6 comprising
a tractor having an oxidant blend tank for storing the oxidant solution therein, the blend tank secured to a front the tractor;
nozzles in fluid communication with the oxidant blend tank for directing and spraying the oxidant solution onto the contaminated soil; and
a reversely rotating soil mulcher secured to a rear of the tractor for concurrently blending the contaminated soil sprayed with oxidant solution.
